(19) United States
(12) Patent Application Publication
(10) Pub. No.: US 2009/0278904 A1
(43) Pub. Date: Nov. 12, 2009

(54) Inkjet apparatus

(75) Inventors: Sung-II Oh, Seoul (KR); Jae-Woo Jung, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD, Suwon (KR)

(21) Appl. No.: 12/320,796

(22) Filed: Feb. 4, 2009

(30) Foreign Application Priority Data
May 9, 2008 (KR) 10-2008-0043205

(51) Int. Cl. B41J 2/17

(52) U.S. Cl. 347/96

(57) ABSTRACT

An inkjet apparatus is disclosed. The inkjet apparatus for printing a solder resist can include: a first reservoir storing a monomer composition, a second reservoir storing a hardening agent composition, and an inkjet head, which can be connected to the first reservoir and the second reservoir to eject the monomer composition and the hardening agent composition. By utilizing an inkjet apparatus according to certain embodiments of the invention as set forth above, the occurrence of blockage in the nozzles caused by ink solidified inside the inkjet head and reservoir can be prevented. Also, the problem of spreading of the ink during printing can be resolved, and the thermal resistance, chemical resistance, and abrasion resistance of the solder resist after inkjet printing can be improved.

### CROSS-REFERENCE TO RELATED APPLICATIONS

This application claims the benefit of Korean Patent Application No. 10-2008-0043205 filed with the Korean Intellectual Property Office on May 9, 2008, the disclosure of which is incorporated herein by reference in its entirety.

### BACKGROUND

1. Technical Field

The present invention relates to an inkjet apparatus.

2. Description of the Related Art

The operation of printing solder resist, as included in the manufacture of a printed circuit board for use in electronic equipment, may entail a series of complicated processes, such as applying solder resist ink using screen-printing or roll-coating, fabricating a photomask, exposing to ultraviolet rays, developing, cleansing, and drying, etc.

Recently, the demands have increased for inexpensive methods of manufacturing electronic equipment, spurred by trends towards providing electronic equipment in lower costs. There has also been an increase in the demands for establishing an environment-friendly manufacturing process, such as by reducing the use of organic solvents hitherto used in large quantities in the processes for developing, etching, delaminating, and cleansing, etc. Accordingly, digital manufacturing processes, such as those employing inkjet printing, are currently receiving much attention.

The conventional process for printing solder resist may entail processes for applying solder resist ink, e.g. using screen-printing or roll-coating, and drying the solder resist ink. In addition, a process of fabricating a mask may be included, for removing certain portions of the coated solder resist, as well as other processes such as exposing, developing, cleansing, and drying processes.

In order to prevent unevenness in the coated layer and the transfer of impurities, which are apt to occur when coating a liquid ink, a method has recently been proposed of laminating a film type solder resist and then implementing a desired pattern by photolithography.

However, even when using a solder resist provided in the form of a film, the photolithography processes, i.e. exposure and development processes, etc., cannot be eliminated. This, together with the increase in material costs resulting from the fabrication of the film, may considerably increase the costs for manufacturing a printed circuit board.

To resolve this, a solder resist layer may be implemented by using an inkjet printing method to print a one-component solder resist ink made of a monomer composition and a hardening agent composition. Here, although the solder resist ink for inkjet printing may have a lower viscosity value compared to inks used for screen-printing, the viscosity may still be too high (about 300 cP), making it impossible to proceed with the inkjet printing at normal temperature. As such, a method has been proposed of lowering the viscosity of the ink at the ejection portion by raising the temperature (to about 35-70° C.) at the inkjet head and the reservoir when printing the ink.

However, the solder resist ink may contain a thermosetting chemical for hardening the ink after it is filled in the holes of the printed circuit board, and as the temperatures at the inkjet head and the reservoir are increased, some of the ink may be solidified inside the inkjet head. As such, the viscosity of the ink may actually increase, and the solidified ink may block the inkjet head nozzles, making it impossible to proceed with the inkjet printing.

Furthermore, to accommodate the manufacture of current electronic equipment that are being produced in smaller and smaller sizes, a high level of printing resolution is required in printing the solder resist. Here, the solder resist ink conditioned with a reactive diluent and an organic solvent to lower viscosity can have a low viscosity value of about 100 cP at normal temperature. This low viscosity may cause excessive spreading of the ink, after the ink is ejected from the inkjet head when the ink reaches the substrate, whereby it may be very difficult to print fine-lined patterns.

In order to lower the viscosity of solder resist ink for printing, a large amount of reactive or non-reactive diluent may be used. However, adding a large quantity of diluents can greatly degrade the properties of the solder resist after printing, in terms of resistance to heat, resistance to chemicals, and resistance to abrasion, etc. If a volatile organic solvent is used instead of a diluent, only a small amount of non-volatile components may remain, making it difficult to obtain a sufficient thickness for the coated layer.

### SUMMARY

An aspect of the invention provides an inkjet apparatus that can be used to prevent nozzle blockage caused by ink solidified inside the inkjet head and the reservoir, resolve problems of spreading when printing the ink, and resolve problems in thermal resistance, chemical resistance, and abrasion resistance after the inkjet printing.

Another aspect of the invention provides an inkjet apparatus for printing a solder resist that can include: a first reservoir storing a monomer composition, a second reservoir storing a hardening agent composition, and an inkjet head, which can be connected to the first reservoir and the second reservoir to eject the monomer composition and the hardening agent composition.

The inkjet head can include a first inkjet head, which may be connected to the first reservoir to eject the monomer composition, and a second inkjet head, which may be connected to the second reservoir to eject the hardening agent composition.

The inkjet apparatus can further include a first ink supply tube, which may connects the first reservoir and the first inkjet head, and can also include a second ink supply tube, which may connect the second reservoir and the second inkjet head.

The inkjet head can include a first nozzle line, which may eject the monomer composition, and a second nozzle line, which may eject the hardening agent composition.

The monomer composition can include a UV-curable acrylate compound, a thermosetting functional group-containing compound, a reactive or non-reactive diluent, and a colorant.

Here, the UV-curable acrylate compound may include one of a methacroyl group and an acroyl group.

Also, the thermosetting functional group-containing compound may be an acrylic compound that includes one or more selected from a set consisting of hydroxyl groups (—OH), carboxyl groups (—COOH), isocyanate groups (—NCO), amino groups (—NH₂), mercapto groups (—SH), ethoxymethyl groups, methoxymethyl groups, and oxazoline groups.

The reactive or non-reactive diluent may include one or more selected from a set consisting of vinyl ether, ethylene derivatives, styrene, chloromethylstyrene, α-methylstyrene, maleic anhydride, dicyclopentadiene, N-vinylpyrrolidone, N-vinylformamide, 3-ethyl-3-(phenoxymethyl)oxetane, xylidene dioxetane, and oxetane alcohol.

The colorant may be an inorganic pigment that includes one or more selected from titanium dioxide (TiO₂), Prussian blue, phthalocyanine, cadmium sulfide, iron oxide, viridian, ultramarine, and chrome.

The hardening agent composition can include a radical photopolymerization initiator or a cationic photopolymerization initiator, and a non-reactive diluent and a colorant.

Here, the radical photopolymerization initiator may include one or more selected from a set consisting of anthraquinone, anthraquinone substituted with alkyl and halogen, benzoin, benzoin alkyl ether, acetophenone, and thiol.

Also, the cationic photopolymerization initiator may include one or more selected from a set consisting of iodonium salts, bromonium salts, cloronium salts, sulfonium salts, selenonium salts, pyrylium salts, and thiapyrylium salts.

The non-reactive diluent may include one or more selected from a set consisting of vinyl ether, ethylene derivatives, styrene, chloromethylstyrene, α-methylstyrene, maleic anhydride, dicyclopentadiene, N-vinylpyrrolidone, N-vinylformamide, 3-ethyl-3-(phenoxymethyl)oxetane, xylidene dioxetane, and oxetane alcohol.

Also, the colorant may be an inorganic pigment that includes one or more selected from titanium dioxide, Prussian blue, phthalocyanine, cadmium sulfide, iron oxide, viridian, ultramarine, and chrome.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a schematic drawing illustrating an inkjet apparatus according to an embodiment of the invention.

FIG. 2 is a schematic drawing illustrating the inkjet head in the inkjet apparatus shown in FIG. 1.

FIG. 3 is a schematic drawing illustrating an inkjet apparatus according to another embodiment of the invention.

FIG. 4 is a cross sectional view illustrating the nozzle lines of the inkjet head in the inkjet apparatus shown in FIG. 3.

### DETAILED DESCRIPTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first” and “second,” etc., may be used to describe various elements, such elements must not be limited to the above terms. The above terms are used only to distinguish one element from another.

The terms used in the present specification are merely used to describe particular embodiments, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

The inkjet apparatus according to certain embodiments of the invention will be described below in more detail with reference to the accompanying drawings. Those elements that are the same or are in correspondence are rendered the same reference numeral regardless of the figure number, and redundant explanations are omitted.

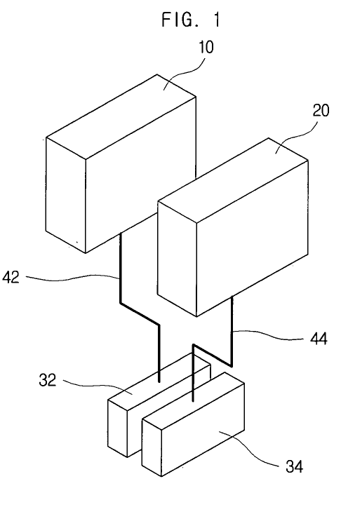

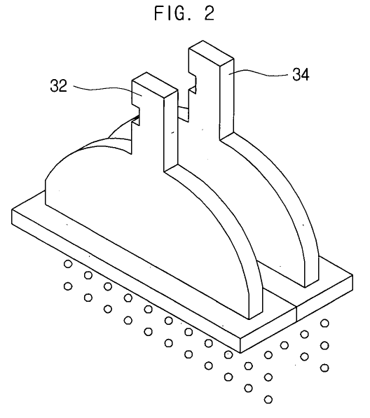

FIG. 1 is a schematic drawing illustrating an inkjet apparatus according to an embodiment of the invention, and FIG. 2 is a schematic drawing illustrating the inkjet head in the inkjet apparatus shown in FIG. 1.

In FIG. 1 and FIG. 2, there are illustrated a first reservoir 10, a second reservoir 20, a first inkjet head 32, a second inkjet head 34, a first ink supply tube 42, and a second ink supply tube 44.

In order to resolve problems of the conventional system for printing a solder resist using an inkjet printing method, where a one-component solder resist ink is used that in which a monomer composition and a hardening agent composition are mixed together, this embodiment provides a system that includes a first reservoir storing a monomer composition and a second reservoir storing a hardening agent composition, where the compositions may be ejected through different inkjet heads or different inkjet head nozzles.

Therefore, the monomer composition and the hardening agent composition may not be mixed inside the inkjet head, but may be mixed after ejection. Thus, there may be higher ink stability within the inkjet head, and an ink having a higher viscosity may be prepared to increase printing resolution.

The solder resist ink can be a composition for forming a permanent insulating layer that protects the outer circuits of a printed circuit board from the external environment and allows selective soldering over the portions for mounting parts.

By forming an insulating layer with the solder resist ink, the copper circuits can be prevented from being directly exposed to the atmosphere and can thereby be prevented from oxidation or corrosion due to air or moisture.

Also, a photocurable and thermosetting photoresist can be included, which inhibits breakage in the insulation when a part is mounted on the board, and which maintains a high reliability in the electric circuits in extreme climate environments.

In general, the solder resist ink may include monomers that are reactive to ultraviolet irradiation, a hardening agent that induces a photoreaction, and a large quantity of inorganic filler for alleviating thermal impact.

This solder resist ink may be a high-viscosity composition suitable for screen-printing and may typically have a dynamic viscosity of about 300 Poise. While various reactive diluents may be used to adjust the viscosity, the viscosity value may be too high for printing through an inkjet head, making it difficult to employ the ink directly in inkjet printing processes.

This embodiment relates to an inkjet apparatus for printing a solder resist, where a first reservoir 10 stores a monomer composition and a second reservoir 20 stores a hardening agent composition.

Here, the monomer composition can be composed of a UV-curable acrylate compound, a thermosetting functional group-containing compound, a reactive or non-reactive diluent for lowering viscosity, a colorant for implementing the ink color, and additives such as a surfactant, etc.

The UV-curable acrylate compound can be a compound that contains a methacroyl group or an acroyl group, where the compound can include monomers, which have low molecular weights, and/or oligomers or polymers, which have high molecular weights. For easy inkjet ejection, a compound having an average molecular weight of 10,000 or lower may be more advantageous.

The thermosetting functional group-containing compound can be an acrylic compound that includes one or more selected from a set consisting of hydroxyl groups, carboxyl groups, isocyanate groups, amino groups, mercapto groups, ethoxymethyl groups, methoxymethyl groups, and oxazoline groups.

The reactive or non-reactive diluent can include one or more selected from a set consisting of vinyl ether, ethylene derivatives, styrene, chloromethylstyrene, α-methylstyrene, maleic anhydride, dicyclopentadiene, N-vinylpyrrolidone, N-vinylformamide, 3-ethyl-3-(phenoxymethyl)oxetane, xylidene dioxetane, and oxetane alcohol.

The colorant can advantageously be an inorganic pigment, which may include, for example, one or more selected from titanium dioxide, Prussian blue, phthalocyanine, cadmium sulfide, iron oxide, viridian, ultramarine, and chrome.

Also, the hardening agent composition can be can be an initiator composition and can be composed of a radical photopolymerization initiator or a cationic photopolymerization initiator for inducing a photopolymerization reaction, a non-reactive diluent, and additives.

The photoinitiator compounds can serve to initiate and facilitate the polymerization of the acrylate compounds in the monomer composition.

First, the radical photopolymerization initiator can be a compound that includes one or more selected from a set consisting of anthraquinone, anthraquinone substituted with alkyl and halogen, benzoin, benzoin alkyl ether, acetophenone, and thiol.

The cationic photopolymerization initiator can be a compound that includes one or more selected from a set consisting of iodonium salts, bromonium salts, cloronium salts, sulfonium salts, selenonium salts, pyrylium salts, and thiapyrylium salts.

While the non-reactive or reactive diluent and additives can be the same as those used for the monomer composition, it can be advantageous to use non-reactive diluents to provide greater stability in the head and the reservoir.

As illustrated in FIG. 1, the inkjet head can be composed of a first inkjet head 32, which may be connected with the first reservoir 10 to eject the monomer composition, and a second inkjet head 34, which may be connected with the second reservoir 20 to eject the hardening agent composition.

By separating the monomer composition and the hardening agent composition in their respective reservoirs and using an arrangement of two inkjet heads for ejecting the compositions separately, the monomer composition can be heated in the first inkjet head 32 to lower the viscosity for ejection, while the hardening agent composition can be heated for ejection in the second inkjet head 34.

In this way, blockage in the nozzles, caused by solidified ink when the ink is heated inside the inkjet head to lower viscosity, may be prevented. That is, since the viscosity of the solder resist ink may be too high (300 cP) to allow inkjet printing at normal temperature, the temperature in the inkjet head and reservoir can be raised to 35 to 60° C. during inkjet ejection to lower the viscosity of the ink at the ejection portion.

As the monomer composition and hardening agent composition forming the solder resist ink may be stored separately in different reservoirs, the temperature increase for lowering the viscosity of the ink can be prevented from solidifying the ink, preventing the occurrence of solidified particles blocking the nozzles of the inkjet head.

The first ink supply tube 42 can connect the first reservoir 10 with the first inkjet head 32 and allow the monomer composition to pass, while the second ink supply tube 44 can connect the second reservoir 20 with the second inkjet head 34 and allow the hardening agent composition to pass.

As illustrated in FIG. 2, the first inkjet head 32 and the second inkjet head 34 can be separated, so that the monomer composition and the hardening agent composition may be ejected independently. Since the monomer composition and the hardening agent composition may be printed in adjacent portions, the two compositions may be mixed together after ejection to implement the solder resist ink.

In addition, the first inkjet head 32 and the second inkjet head 34 can be controlled independently to adjust the amount of monomer composition and hardening agent composition ejected through each head. Thus, printed patterns of various mixture ratios for the monomers and initiators can be formed on the substrate, so that a solder resist layer may be formed by inkjet printing using post UV curing and thermal curing over the desired portions of a circuit pattern.

With the conventional one-component UV-curable ink, the temperature in the reservoir and nozzle part may not be raised to above 50° C., or the ink may solidify inside the head. As such, the viscosity of the ink may be adjusted so that the ink may be ejected after raising the temperature to a relatively lower degree. Such ink may be prepared with a viscosity of 100 cP or lower at normal temperature.

In those cases where the viscosity at normal temperature is 100 cP or lower, spreading of the ink may have to be suppressed by hardening the ink, if a high resolution is to be obtained.

In this embodiment, however, a two-component ink may be prepared, in which the monomer composition and the hardening agent composition are separated. Thus, the risk of ink solidifying inside the head can be eliminated, and the temperature in the reservoir and nozzles can be raised to a high level of 50° C. or higher, whereby the spreading of the ink after ejection can be prevented, and a printed pattern can be implemented with a high resolution.

Also, in order to provide a low viscosity, a one-component solder resist ink may generally use smaller amounts of monomers, which are higher in molecular weight, and larger amounts of diluent.

On the contrary, in the two-component solder resist according to this embodiment, the monomer composition and the initiator composition can be separated, and the temperature in the inkjet head can hence be increased, whereby the content of monomers high in molecular weight can be increased, and the amount of diluent can be decreased. Therefore, when the two-component solder resist ink is used, a greater level abrasion resistance may be obtained.

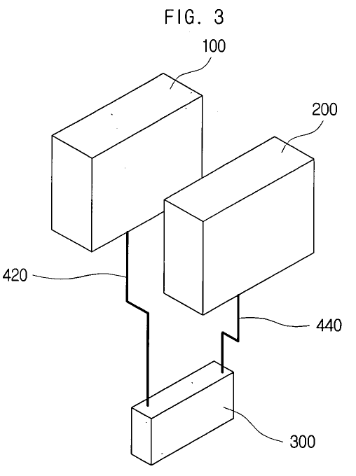

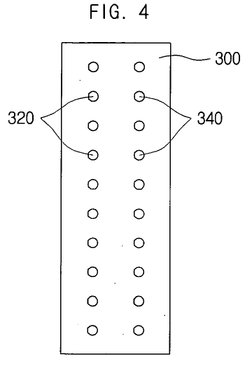

FIG. 3 is a schematic drawing illustrating an inkjet apparatus according to another embodiment of the invention, and FIG. 4 is a cross sectional view illustrating the nozzle lines of the inkjet head in the inkjet apparatus shown in FIG. 3.

In FIG. 3 and FIG. 4, there are illustrated a first reservoir 100, a second reservoir 200, an inkjet head 300, a first nozzle line 320, a second nozzle line 340, a first ink supply tube 420, and a second ink supply tube 440.

The inkjet apparatus illustrated in this embodiment differs from the inkjet apparatus according to the embodiment described with reference to FIGS. 1 and 2 in the structure of the inkjet head. Thus, the following descriptions will focus on this difference, and descriptions that are redundant from the descriptions provided for the embodiment in FIGS. 1 and 2 will be omitted.

As illustrated in FIG. 3, the inkjet head 300 can be connected to both the first reservoir 100 and the second reservoir 200. That is, the first ink supply tube 420 and the second ink supply tube 440 can be connected to a single inkjet head 300.

Although the monomer composition and the hardening agent composition may both enter the inkjet head 300, the inside of the inkjet head 300 can be formed to include a first nozzle line 320 for ejecting the monomer composition and a second nozzle line 340 for ejecting the hardening agent composition, as illustrated in FIG. 4.

Therefore, the monomer composition and the hardening agent composition can be ejected independently without mixing with each other, so that the temperature in the reservoir and inkjet head 300 can be raised to lower ink viscosity, without having solidified particles blocking the nozzles.

As the monomer composition and hardening agent composition ejected independently through the first nozzle line 320 and second nozzle line 340 may be printed in adjacent positions, the compositions can be mixed together after ejection to implement a solder resist layer.

### PREPARATION EXAMPLE 1

### Preparation of a Two-Component Inkjet Solder Resist Ink

Using a high-speed stirrer, 375 g of 2-hydroxyethyl acrylate, 525 g of 2-methacryloyl-oxyethyl isocyanate, 75 g of 3-ethyl-3-(phenoxymethyl)oxetane, and 7.5 g of a Solsperse dispersant were evenly mixed together. The mixture was dispersed, together with 75 g of a phthalocyanine inorganic pigment and 225 g of a barium sulfate inorganic pigment, using a beads mill system, after which the mixture was filtered through a 1 μm filter to prepare the monomer composition of a two-component solder resist ink.

A mixture of 150 g of 3-ethyl-3-(phenoxymethyl)oxetane, 45 g of azobisisovaleronitrile, and 75 g of an antifoaming agent and additives were stirred at high speeds and filtered through a 1 μm filter to prepare the initiator composition of the two-component solder resist ink.

### COMPARATIVE EXAMPLE 1

### Preparation of a One-Component Inkjet Solder Resist Ink

Using a high-speed stirrer, 300 g of 2-hydroxyethyl acrylate, 525 g of 2-methacryloyl-oxyethyl isocyanate, and 7.5 g of a Solsperse dispersant were evenly mixed together. The mixture was dispersed, together with 75 g of a phthalocyanine inorganic pigment and 225 g of a barium sulfate inorganic pigment, using a beads mill system.

To the dispersed liquid prepared as above, 41.3 g of azobisisovaleronitrile, 300 g of 3-ethyl-3-(phenoxymethyl)oxetane, and 75 g of an antifoaming agent and additives were mixed in. The mixture was stirred at high speeds and filtered through a 1 μm filter to prepare a one-component solder resist ink.

### TEST EXAMPLE

The two-component solder resist ink and the one-component solder resist ink prepared in Preparation Example 1 and Comparative Example 1 were printed on a substrate. Evaluation results are listed below in Table 1.

TABLE 1

| | One-Component | Two-Component |
|---|---|---|
| | Solder Resist Ink | Solder Resist Ink |
| Duration of Ejection | 10 minutes or less | 30 minutes or more |
| (Ejection Stability) | | |
| Minimum Linewidth | 155 μm | 100 μm |
| (Spreading) | | |
| Pencil Hardness | 3H | 7H |
| (Abrasion Resistance) | | |

As shown in Table 1, forming the solder resist layer on a substrate using a two-component solder resist ink, in which the monomer composition and the hardening agent composition are separated, may provide longer ejection times and thus greater ejection stability, and may implement thinner linewidths to suppress spreading. Also, the pencil hardness may be greater, compared to the one-component solder resist ink, and thus abrasion resistance may be greater.

By utilizing an inkjet apparatus according to certain embodiments of the invention as set forth above, the occurrence of blockage in the nozzles caused by ink solidified inside the inkjet head and reservoir can be prevented. Also, the problem of spreading of the ink during printing can be resolved, and the thermal resistance, chemical resistance, and abrasion resistance of the solder resist after inkjet printing can be improved.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. An inkjet apparatus for printing a solder resist, the inkjet apparatus comprising:
a first reservoir storing a monomer composition;
a second reservoir storing a hardening agent composition; and
an inkjet head, the inkjet head connected to the first reservoir and the second reservoir and configured to eject the monomer composition and the hardening agent composition.

2. The inkjet apparatus of claim 1, wherein the inkjet head comprises:
a first inkjet head connected to the first reservoir and configured to eject the monomer composition; and
a second inkjet head connected to the second reservoir and configured to eject the hardening agent composition.

3. The inkjet apparatus of claim 2, further comprising:
a first ink supply tube connecting the first reservoir and the first inkjet head.

4. The inkjet apparatus of claim 2, further comprising:
a second ink supply tube connecting the second reservoir and the second inkjet head.

5. The inkjet apparatus of claim 1, wherein the inkjet head comprises:
a first nozzle line configured to eject the monomer composition; and
a second nozzle line configured to eject the hardening agent composition.

6. The inkjet apparatus of claim 1, wherein the monomer composition comprises a UV-curable acrylate compound, a thermosetting functional group-containing compound, a reactive or non-reactive diluent, and a colorant.

7. The inkjet apparatus of claim 6, wherein the UV-curable acrylate compound includes one of a methacroyl group and an acroyl group.

8. The inkjet apparatus of claim 6, wherein the thermosetting functional group-containing compound is an acrylic compound including one or more selected from a set consisting of hydroxyl groups (—OH), carboxyl groups (—COOH), isocyanate groups (—NCO), amino groups (—NH₂), mercapto groups (—SH), ethoxymethyl groups, methoxymethyl groups, and oxazoline groups.

9. The inkjet apparatus of claim 6, wherein the reactive or non-reactive diluent includes one or more selected from a set consisting of vinyl ether, ethylene derivatives, styrene, chloromethylstyrene, α-methylstyrene, maleic anhydride, dicyclopentadiene, N-vinylpyrrolidone, N-vinylformamide, 3-ethyl-3-(phenoxymethyl)oxetane, xylidene dioxetane, and oxetane alcohol.

10. The inkjet apparatus of claim 6, wherein the colorant is an inorganic pigment including one or more selected from titanium dioxide (TiO₂), Prussian blue, phthalocyanine, cadmium sulfide, iron oxide, viridian, ultramarine, and chrome.

11. The inkjet apparatus of claim 1, wherein the hardening agent composition comprises a radical photopolymerization initiator or a cationic photopolymerization initiator, a non-reactive diluent, and a colorant.

12. The inkjet apparatus of claim 11, wherein the radical photopolymerization initiator includes one or more selected from a set consisting of anthraquinone, anthraquinone substituted with alkyl and halogen, benzoin, benzoin alkyl ether, acetophenone, and thiol.

13. The inkjet apparatus of claim 11, wherein the cationic photopolymerization initiator includes one or more selected from a set consisting of iodonium salts, bromonium salts, cloronium salts, sulfonium salts, selenonium salts, pyrylium salts, and thiapyrylium salts.

14. The inkjet apparatus of claim 11, wherein the non-reactive diluent includes one or more selected from a set consisting of vinyl ether, ethylene derivatives, styrene, chloromethylstyrene, α-methylstyrene, maleic anhydride, dicyclopentadiene, N-vinylpyrrolidone, N-vinylformamide, 3-ethyl-3-(phenoxymethyl)oxetane, xylidene dioxetane, and oxetane alcohol.

15. The inkjet apparatus of claim 11, wherein the colorant is an inorganic pigment including one or more selected from titanium dioxide, Prussian blue, phthalocyanine, cadmium sulfide, iron oxide, viridian, ultramarine, and chrome.
